(19) United States
(12) Patent Application Publication
(10) Pub. No.: US 2006/0021932 A1
(43) Pub. Date: Feb. 2, 2006

(54) Integrated flat panel filter and housing

(76) Inventors: Justin R. Darnell, Olive Branch, MS (US); Lester E. Holmes, South Haven, MS (US)

Correspondence Address: Warren A. Sklar, Esq.;Renner, Otto, Boisselle & Sklar, 1621 Euclid Ave. - 19th Floor, Cleveland, OH, 44115, US

(21) Appl. No.: 11/189,433

(22) Filed: Jul. 26, 2005

Related U.S. Application Data
(60) Provisional application No. 60/591,122, filed on Jul. 26, 2004.

(51) Int. Cl. B01D 35/02

(52) U.S. Cl. 210/459; 210/450; 210/462; 210/463

(57) ABSTRACT

A flat panel filter to filter air flowing in an inline fluid duct system as an air supply system for an engine or the like includes a housing configured as a section of an inline fluid flow duct of an inline fluid duct system, the housing having a flow path including a fluid inlet to receive air flow from an inlet fluid duct portion of such inline fluid duct system and a fluid outlet to provide air flow to an outlet fluid duct portion of such inline fluid duct system, a filter in the housing, and a connector configured to connect the housing as an inline fluid flow section of such inline fluid duct system between such inlet fluid duct portion and outlet fluid duct portion of such an inline fluid duct system, the connector including a number of hook-like fingers of the housing, respectively, at least proximate a respective fluid inlet and fluid outlet of the housing to provide a sliding relation and resiliently biased connection with respective inlet and outlet fluid duct portions of such inline fluid duct system. Detents resist sliding of the hook-like fingers relative to the inlet and outlet duct portions; a lock is selectively operable to lock or to unlock connection between the flat panel filter and the inlet and outlet duct portions; and a gasket seals the connection between the flat panel filter and the inlet and outlet duct portions.

Priority of U.S. provisional patent application Ser. No. 60/591,122, filed Jul. 26, 2004, is claimed.

### FIELD OF THE INVENTION

The present invention related generally, as indicated, to an integrated flat panel filter and housing, and more particularly to such a filter and housing configured as a removable and replaceable segment of an inline fluid flow duct system.

### BACKGROUND OF THE INVENTION

In a typical filter assembly used in an inline fluid flow duct system a housing contains a removable and replaceable material. The housing typically includes a cover that can be opened or removed to remove and replace filter material in the housing. It is possible to break the cover or to lose it when it is open or removed, a disadvantage of convention filter assemblies. Sometimes conventional tools, e.g., a screwdriver, wrench, etc., may be required to open and to close the filter housing, another disadvantage of conventional filter assemblies.

Various types of filter materials have been used to effect filtering to remove particles from a fluid. An exemplary filter material is pleated paper filter material. A pressure drop occurs between the inlet and outlet sides of a pleated paper filter. The more compressed the pleats to obtain increased surface area of the paper, the greater the pressure drop. Usually it is advantageous to minimize such pressure drop, on the one hand, while providing for a relatively large surface area of the paper to effect the filtering function.

### SUMMARY OF THE INVENTION

In the description below the integrated flat panel filter and housing is described with respect to use to filter a particulate material from a fluid, such as, for example, air or other gas. An embodiment described below is used to filter air in the air flow system that supplies air for use in combustion in an engine, such as a vehicle engine. The filter may be used in other environments to filter air and other gas fluids and may be used to filter liquid fluids.

An aspect of the invention relates to a flat panel filter, including a housing configured as a section of an inline fluid flow duct, a filter in the housing, and a connector configured to connect the housing with at least part of such an inline fluid flow duct, the connector including at least one hook-like finger configured to engage an inline fluid flow duct to resist removal of the housing from such an inline fluid flow duct.

Another aspect relates to a flat panel filter to filter air flowing in an inline fluid duct system as an air supply system for an engine, including a housing configured as a section of an inline fluid flow duct of an inline fluid duct system, the housing having a flow path including a fluid inlet to receive air flow from an inlet fluid duct portion of such inline fluid duct system and a fluid outlet to provide air flow to an outlet fluid duct portion of such inline fluid duct system, a filter in the housing, and a connector configured to connect the housing as an inline fluid flow section of such inline fluid duct system between such inlet fluid duct portion and outlet fluid duct portion of such an inline fluid duct system, the connector including a number of hook-like fingers of the housing, respectively, at least proximate a respective fluid inlet and fluid outlet of the housing to provide a sliding relation and resiliently biased connection with respective inlet and outlet fluid duct portions of such inline fluid duct system.

Another aspect of the invention relates to an integrated flat panel filter and housing in which a pleated paper filter material is molded directly in a plastic duct section of an inline fluid flow duct system.

Another aspect relates to a plastic frame that captures filter material and holds that material as an integrated structure and is a section of the air intake duct for an engine.

Another aspect relates to an integrated flat panel filter and housing configured as a section of an inline fluid flow duct that can be connected to other sections of the inline fluid flow duct without tools.

Another aspect relates to a method of installing an integrated flat panel filter and housing section of an inline fluid flow duct system in which the section is resiliently retained and locked to an inlet duct and to an outlet duct.

These and other aspects, features, objects and advantages of the present invention will become more apparent with reference to the following description and the annexed drawings.

To the accomplishment of the foregoing and related ends, the invention comprises the features hereinafter fully described and particularly pointed out in the claims. The following description and the annexed drawings set forth in detail an illustrative embodiment of the invention. This embodiment, however, is merely indicative of one of various ways in which the principles of the invention may be employed.

Although the invention is shown and described with respect to one embodiment, it is obvious that equivalents and modifications will occur to others skilled in the art upon the reading and understanding of the specification. The present invention includes all such equivalents and modifications, and is limited only by the scope of the claims.

### DRAWINGS

In the annexed drawings:

FIG. 1 is a schematic exploded illustration of an inline fluid duct system;

FIG. 2 is a schematic illustration of assembled inline fluid duct system;

FIG. 3 is an isometric view of an integrated flat panel filter and housing in accordance with the invention looking at the fluid inlet side from the top angle point of view;

FIG. 4 is an isometric view of the integrated flat panel filter and housing of FIG. 3 looking at the fluid inlet side from the bottom angle point of view;

FIGS. 5 and 6 are isometric views of the inlet fluid duct housing for connection to the integrated flat panel filter and housing, looking, respectively, from the outside and from the inside points of view of that housing; and

FIGS. 7 and 8 are isometric views of the outlet fluid duct housing for connection to the integrated flat panel filter and housing, looking, respectively from the outside and inside points of view of that housing.

### DESCRIPTION

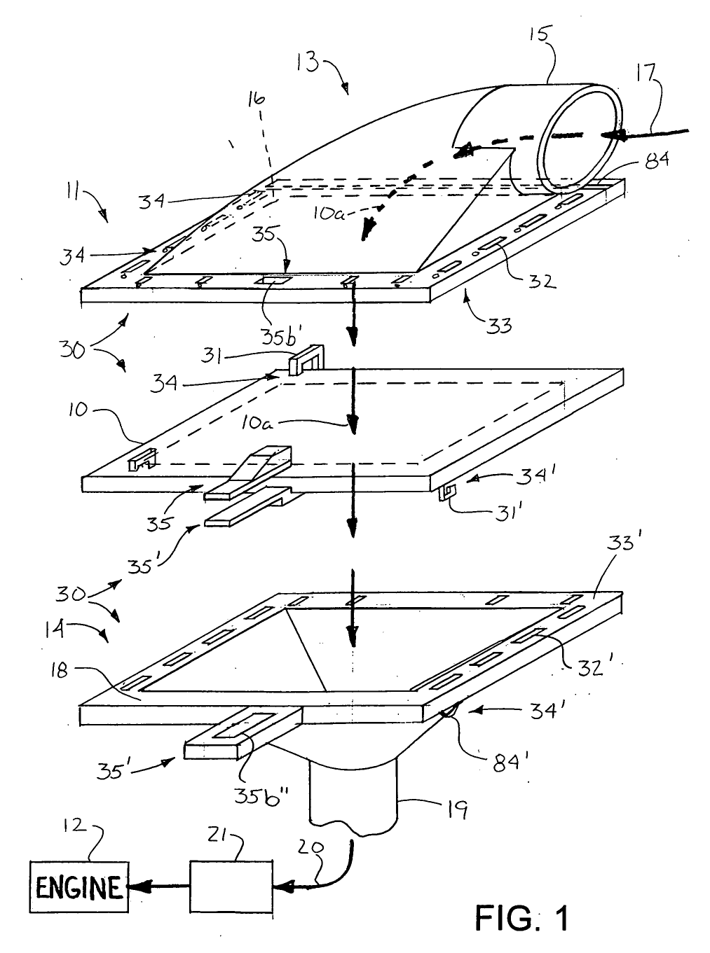

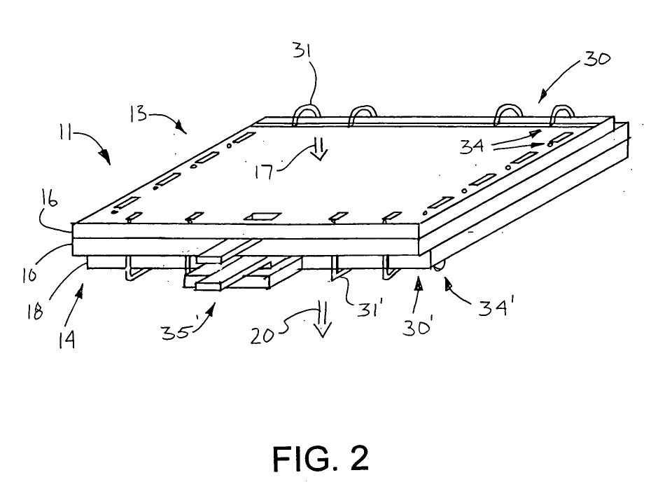

Referring, now, to the drawings, where in like reference numerals designate like parts in the several figures and primed reference numerals designates parts that are either the same or similar to parts that are designated by the same unprimed reference numeral, and initially to FIGS. 1 and 2, an integrated flat panel filter and housing 10 is illustrated in an inline fluid flow duct system 11 associated with an engine 12, such as, for example, the engine of a vehicle. For brevity the integrated flat panel filter and housing 10 sometimes is referred to below as “filter system.” The inline fluid flow duct system 11 may be part of the air supply or intake for a vehicle engine 12, for some other type of engine, or for some other system or function, e.g., an air-conditioning system, etc. The inline fluid flow duct system 11 may be used in connection with a gaseous fluid and/or a liquid fluid to carry fluid; the filter system 10 filters material, e.g., particulates, from the fluid. For brevity the filter system 10 and inline fluid flow duct system 11 is described below with respect to filtering air, e.g., in an air supply system for a vehicle engine 12.

The inline fluid flow duct system 11 includes an air inlet duct portion 13, the integrated flat panel filter and housing (filter system) 10, and an air outlet duct portion 14. In FIG. 1 the parts 13, 10, and 14 are shown schematically in exploded relation generally aligned for assembly, and in FIG. 2 they are illustrated in assembled relation. Some portions of those parts are omitted in FIGS. 1 and/or 2 to simplify the illustrations, e.g., only some hook-like fingers, slots and detents are shown and only portions of the inlet and outlet duct portions 13, 14 are shown, etc.; these portions are illustrated and described with respect to other drawings hereof. Also, although more detail is shown in FIG. 1 than in FIG. 2, FIG. 2 depicts the interconnected relation of the filter system 10 with the inlet and outlet duct housings 16, 18 as part of an inline fluid flow duct system 11.

As is illustrated in FIGS. 1 and 2, the filter system 10 is a section of the inline fluid flow duct system 11. Therefore, if the filter system 10 were removed from interconnection with the air inlet and air outlet duct portions 13, 14, the flow path 10a for air through the inline fluid flow duct system 11 would be incomplete, e.g., there would be an incomplete area between the inlet and outlet duct portions.

The air inlet duct portion 13 includes a flow inlet pipe 15 and an inlet plenum or inlet duct housing 16. The space in the inlet duct housing 16 allows for expansion of the air flow and delivery of the air to the filter system 10 over a relatively large area. Air flow 17 is provided from an ambient source or from some other source to the flow inlet pipe 15, which is coupled as part of the inline fluid flow duct system 11 to the inlet duct housing 16. Air flow is provided via the inlet duct housing 16 through the filter system 10 to the air outlet duct portion 14 and from there for use, for example, in an engine 12 or for some other use. The air outlet duct portion 14 includes an outlet plenum or outlet duct housing 18, which collects the air from the filter system 10, and an outlet pipe 19 from which air flow 20 is provided as the fluid output from the inline fluid flow duct system 11, e.g., to the engine 12 or for some other use.

As it is illustrated in FIG. 1, the inline fluid flow duct system 11 is vertically oriented with the air inlet duct portion 13 at the top and the air outlet duct portion 14 at the bottom. Such orientation is not critical. The orientation may be reversed from that illustrated or the orientation may be horizontal whereby the flow through the filter system 10 is horizontal rather than in a vertical direction; or the directional orientation of the inline fluid flow duct system may be at some other angle than horizontal or vertical. The actual air flow may be provided by a turbo system 21 associated with the engine 12 to draw air through the inline fluid flow duct system 11.

In the illustrated embodiment the inlet and outlet duct housings 16, 17 are of a larger cross-sectional area relative to air flow therethrough compared to the cross-sectional areas of the flow inlet and flow outlet pipes 15, 19. Accordingly, the inlet and outlet duct housings 16, 18 function as plenums to distribute air over a relatively large area of the filter (described further below) in the filter system 10. Providing the relatively large area tends to improve efficiency of filtering, reduces pressure drop effects, etc.

In use the filter system 10 is inserted as a section of the inline fluid flow duct system 11 between the inlet and outlet duct housings 16, 18 and in generally fluid tight relation therewith. Air drawn by the turbo system 21 associated with the engine 12 is pulled through the inline fluid flow duct system 11, including the filter system 10, and is provided to the engine. When it is desired to change the filter system 10, it can be withdrawn from connection with the inlet and outlet duct housings 16, 18, e.g., leaving a gap or space therebetween, and a clean filter system 10 can be replaced as a section of the inline fluid flow duct system 11 in that gap or space between the inlet and outlet duct housings 16, 18.

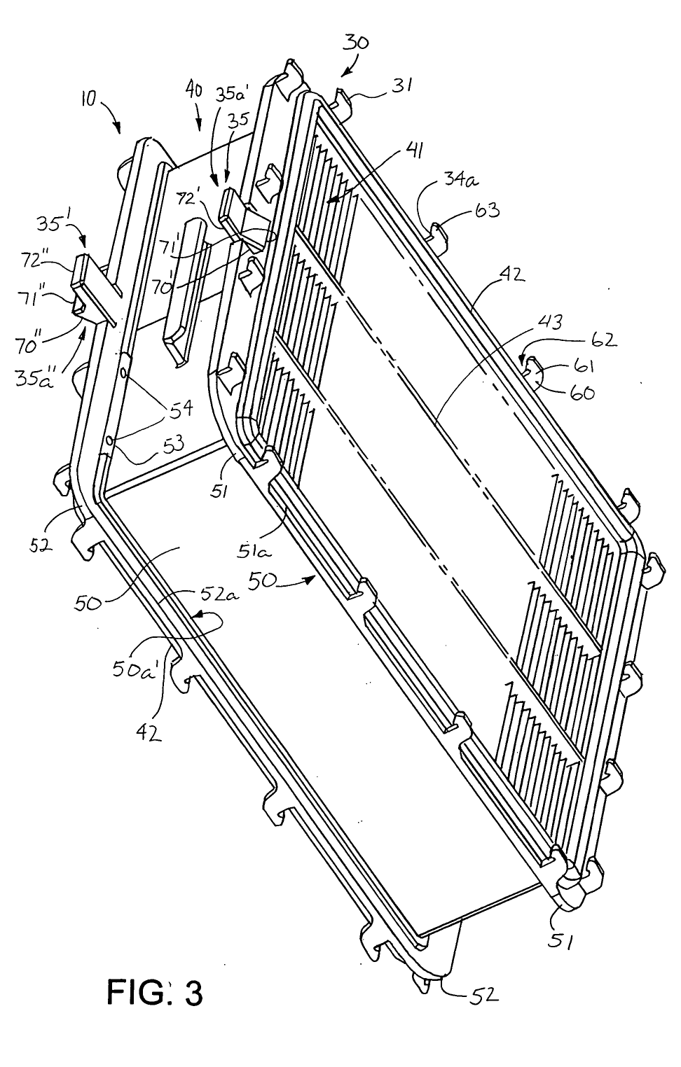

In FIGS. 3-8 the several parts of the connection mechanism 30 by which the filter system 10 is mechanically connected to the inlet and outlet duct housings 16, 18 are illustrated. Although the parts of the connection mechanism 30 are described in further detail below, briefly, the connection mechanism includes hook-like fingers 31, 31′ of the filter system 10 that fit into slots 32, 32′ in the respective inlet and outlet duct housing 16, 18 and slide along those slots and in engagement with a surface 33, 33′ resiliently to draw the filter system 10 and the inlet and outlet duct housings 16, 18 together. A detent arrangement 34, 34′ tends to hold the hook-like fingers 31 in position relative to the respective inlet and outlet duct housings 16, 18 and also may contribute to applying resilient force to urge them together. A lock mechanism 35, 35′ blocks withdrawing of the filter system 10 from the respective inlet and outlet duct housings 16, 18; the lock mechanism may be selectively operated to allow removing of the filter system from the inlet and outlet duct housings.

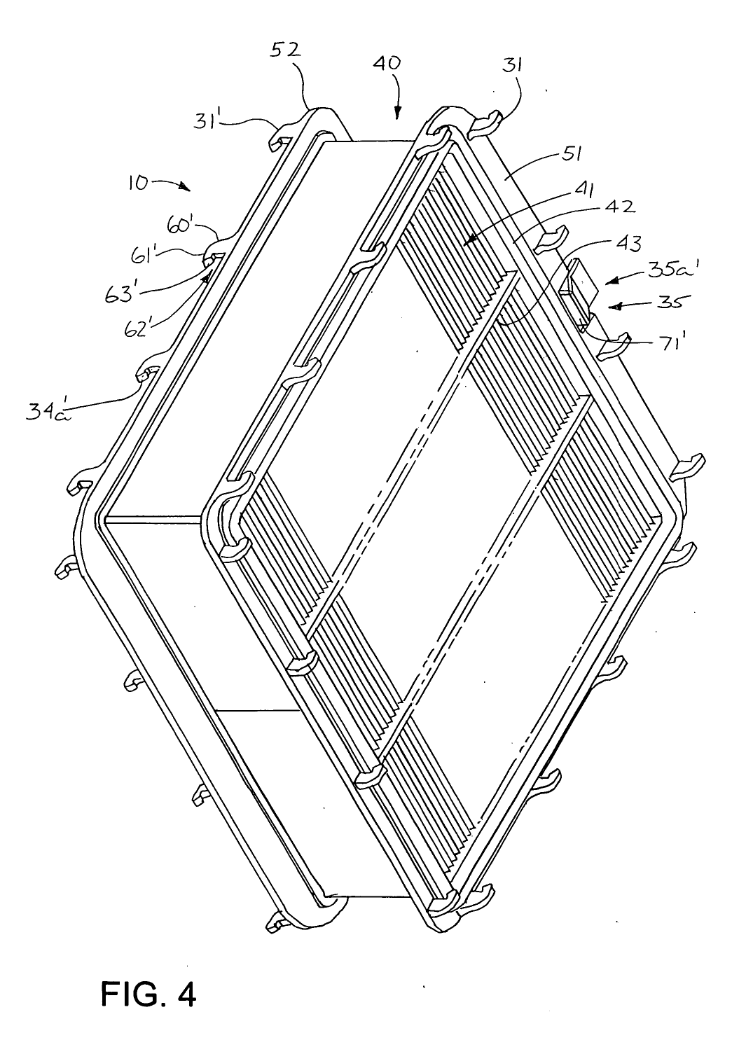

The integrated flat panel filter and housing 10 (also referred to as “filter system” as was mentioned above) is illustrated in FIGS. 3 and 4. The filter system 10 includes a housing 40, a filter 41 in the housing, and parts of the connection mechanism 30, including the hook like fingers 31, detents 34a, and lock portions 35a, 35a′ of the locks 35, 35′. The filter system 10 also includes a gasket 42 to cooperate with the inlet and outlet duct housings 16, 18 to provide a suitable fluid-tight seal therewith.

In the illustrated embodiment the filter 41 is a pleated paper filter that is in the housing 40. The housing 40 may be a plastic or plastic-like material, some other type of polymer, or even another material. As an example, the housing 40 may be made by plastic injection molding. The filter 41 may be secured, held, grasped, etc. to the housing 40 by molding of the housing material directly to the filter material during the plastic injection molding step. Other techniques of placing and/or securing the filter 41 to the housing may be used. Using such plastic injection molding method, the pleated paper filter has substantial support in the housing and, therefore, may use deeper pleats, e.g., having legs that extend in the direction of air flow and are on the order of about 4″, than pleats of prior air filters. The larger the depth of the pleats, the more surface area that is available for filtering air flowing through the filter 41 and, therefore, the lower the pressure drop (and attendant energy losses or energy requirements) that would tend to occur as air flows through the filter. One or more support ribs 43 strengthen the housing 40 and provide additional support for the paper filter 41 tending to prevent the paper from collapsing under the air pressure. The support ribs 43 may be molded integrally with the other parts of the housing 40 or may be otherwise formed and/or installed.

The housing 40 may be molded of nylon 6 material. As was mentioned above, other materials may be used, as desired. The materials may have adequate characteristics to withstand forces, temperatures, etc., to which the filter system 10 may be subjected. The housing 40 has sufficient strength and rigidity to retain its overall shape or configuration so that it readily can be used as a section of an inline fluid flow duct, e.g., as is illustrated in FIGS. 1 and 2, and it also may have adequate flexibility to provide an appropriate amount of forgiving deformation as it is inserted in and removed from an inline fluid flow duct system 11 as a section thereof.

The paper of which the filter 41 is made may be conventional filter paper having pleats of suitable size. Such pleated paper filters are commercially available; the actual filter paper also is commercially available and may be folded, as desired, to achieve the desired lengths of the legs for each pleat. Other material also or alternatively may be used as the filter 41; exemplary materials currently are commercially available and other materials may be developed in the future to carry out filtering functions. If desired, the filter 41 may be molded as part of the housing 40.

The housing 40 has a central housing portion 50 that has a generally rectangular shape, for example, square or non-square. The central housing portion 50 may be of some other shape. The filter 41 is at least partly located in the central housing portion 50. In a sense the central housing portion 50 is like a hollow cylinder of generally rectangular cross-section or the central housing portion may be described as box-like or box-shape, e.g., having a hollow interior in which the filter 41 may be at least partly located. Flanges 51, 52, respectively, extend outwardly from the central housing portion 50, as is illustrated in FIGS. 3 and 4. The flanges 51, 52 may be integrally molded with the central housing portion 50 to form the housing 40 of the integrated flat panel filter and housing 10 (filter system). The flanges 51, 52 may be otherwise formed; for example, they may be internal of the outer generally rectangular cylindrical wall of the central housing, they may be attached to the walls of the housing 40, bent from those walls, molded as part of those walls, etc. The flanges 51, 52 are coordinated in size and shape with flanges or other mating surfaces of the respective inlet and outlet housing ducts 16, 18 to mate with them and to couple the filter system 10 with the inlet and outlet housing ducts, as is described further below.

As is seen in FIGS. 3 and 4, the flanges 51, 52 are generally parallel to each other, are at opposite sides or edges 50a, 50a′ of the wall 50a of the central housing portion 50. The flanges 51, 52 may be formed with an undercut 53 (only one of which partly is shown at a cut away area of FIG. 3) that circumscribes the junctions of the flanges with the wall 50a. The undercut 53 may provide a number of functions, such as, for example, to facilitate molding without breaking of the central housing portion 50 and the flanges 51, 52, e.g., as a stress relief, to provide some degree of flexibility of the flanges relative to the central housing portion 50, and to provide a space for some of the material of the gasket 42, as is described further below. If such added flexibility is provided by the undercut 53, the flexibility or pliability of the flanges relative to the central housing portion 50 may facilitate inserting and removing the filter system 10 as a section of the inline fluid flow duct system 11 between the inlet and outlet duct housings 16, 18 and attachment thereto.

The gasket 42 may be of any suitable material. An exemplary material useful as the gasket 42 is a urethane. The gasket 42 may be molded directly to the housing 40. For example, the housing 40 initially may be molded by a plastic injection molding method or some other method. After the housing 40 has suitably cured, cooled, etc., so that it maintains its shape, the gasket 42 may be molded directly to the housing 40 using a second injection molding step. For example, the housing 40 may be placed in a mold that is suitable for molding the gasket 42 directly to the housing. The housing 40 may be formed with a number of openings 54 at several locations about the housing perimeter, e.g., as is illustrated, at the undercuts 53 (FIG. 3). The material of which the gasket 42 is formed may flow through those openings 54 during molding of the gasket so that a portion of the gasket is facing outward from the housing 40 to engage a respective inlet or outlet duct housing 16, 18, a portion of the gasket material is in the openings 54, and a portion of the gasket material also is in, e.g., fills, the undercut 53 in the respective flange 51, 52 about the perimeter of the housing 40.

As described, the gasket 42 may be molded in place on both sides of each flange so that gasket material is adjacent the outwardly directed face 51a, 52a of the respective flanges 51, 52 and also is in the respective undercuts 53. This approach for molding the gasket directly to the housing 40 provides secure attachment of the gasket. If desired, other approaches may be used to apply a gasket to the housing 40. One example is to use a material that bonds to the material of which the housing 40 is molded. Other conventional approaches for gaskets also may be used, such as, for example, to use an inserted rubber gasket.

As was mentioned above, the connection mechanism 30 (FIGS. 1 and 2) includes a number of hook-like fingers 31, which are spaced about the perimeter of each of the flanges 51, 52. The hook-like fingers 31 are insertable through slots 32 in flanges or other walls of the input and output duct housings 16, 18 and slide along surfaces 33 thereof to hold the filter system 10 and the inlet and outlet duct housings together in the inline fluid flow duct system 11.

The hook-like fingers 31 may be molded as an integral portion of the respective flanges 51, 52 or may be made and subsequently attached to the respective flanges. The hook-like fingers are approximately evenly spaced on the flanges about the perimeter of the housing 40. Equal spacing helps to assure approximately equal pressure or force against the gasket 42 when the filter system 10 is assembled in the inline fluid duct system 11 such that the respective gaskets press against confronting surfaces or the like of respective of inlet and outlet housings 16, 18 to provide suitable sealing function in the duct system 11. Other positioning of the hook-like fingers and associated slots and surfaces also may be used, e.g., to provide increased holding force or compression against the gasket 42 at one location greater than at another location at the interface between the several described parts 10, 16, 18, 42, etc.

As is seen in FIGS. 3 and 4, each of the hook-like fingers 31 has a strut or generally linearly extending support arm 60 that extends away from the respective flange 51, 52 to which it is attached, and also includes an extension arm 61 that extends away from the strut 60 generally in parallel with the flange to which the hook-like finger is attached. The directions expressed here are approximate and are not intended to be limiting. Thus, the strut 60 may extend at a right angle or at an angle other than a right angle from the respective flange to which the hook-like finger is mounted, and the extension arm 61 may be other than parallel to the flange. The strut 60 and extension arm 61 form a hook-like shape having an open area or crevice 62 between the extension arm 61 and the surface of the flange toward which extension arm faces and to which the extension arm is generally parallel. The hook-like fingers 31 are somewhat in the shape of respective teeth that extend out from the respective flanges, as is seen in FIGS. 3 and 4. The hook-like fingers 31 may be relatively square, e.g., as in the shape of the letter “L,” or they may be somewhat curved more like the shape of the letter “J.” The hook-like fingers may be shaped somewhat like a fish hook or may be some other shape, as desired. The hook-like fingers 31 provide aligning of the filter system 10 with the respective inlet and outlet duct housings 16, 18 and a retention function to hold those parts together.

The hook-like fingers 31 of one flange 51, 52 open or face in the opposite direction from the hook-like fingers of the other flange. Thus, the opening or access to the open areas or crevices 62 of the hook-like fingers of the respective flanges 51, 52 are accessible from opposite directions, as can be seen in FIGS. 3 and 4. The oppositely facing orientation of the hook-like fingers allows for the filter system 10 to be slid in opposite directions into connected engagement with respective inlet and outlet duct housings 16, 18. This connection mechanism helps to enhance security and/or strength of the connection between the filter system 10 and the respective inlet and outlet duct housings. As an alternative, the hook-like fingers associated with both flanges 51, 52 may face in the same direction.

The size, shape, strength and material of the hook-like fingers 31 are such that they apply a resilient holding force with respect to the respective inlet and outlet duct housings 16, 18. Thus, the size of the open area 62 of the respective hook-like fingers and the length, shape, angle, etc. of the strut 60 and extension arm 61 provide for such resilient retention. The resilient retention also provides for engagement, for example, compressive engagement, of the gaskets 42 with the respective inlet and outlet duct housing 16, 18 to provide a seal therewith. In such connected and sealed relation the integrated flat panel filter and housing 10 (fluid system) is a section of the inline fluid flow duct system 11 as are the inlet and outlet duct housings 16, 18, flow inlet and outlet pipes 15, 19, etc.

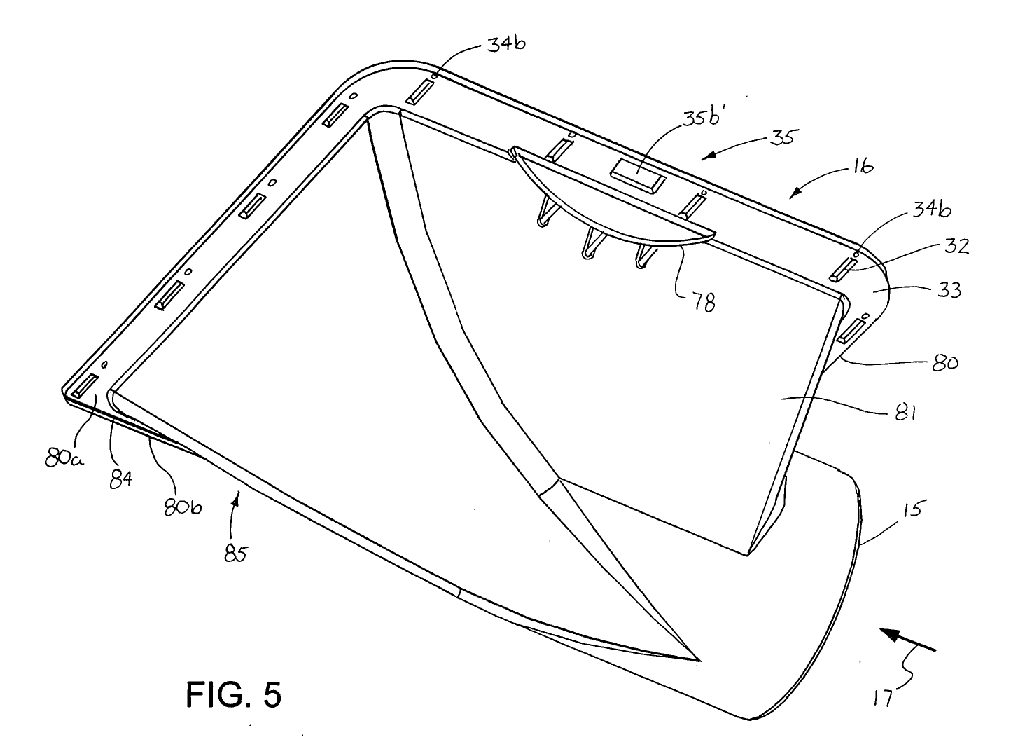

One or more, for example, all, of the hook-like fingers have a detent 34a. The detent 34a cooperates with a corresponding detent 34b (FIGS. 5-8) of the respective inlet and outlet duct housing 16, 18, to retain the hook-like fingers appropriately engaged with the inlet and outlet duct housings. As is illustrated in FIGS. 3 and 4, the detent 34a is a protrusion 63 at the distal end of the extension arm 61 relative to the strut 60. The protrusion 63 may be located elsewhere along the extension arm 61, if desired. The protrusion may be the only portion of the extension arm 61 that engages the respective inlet and outlet duct housing 16, 18. Alternatively, one or more of the hook-like fingers 31 may be configured so that one or more other parts of the extension arm 61 would engage a respective inlet and outlet duct housing 16, 18, e.g., using a different angular relation of the strut 60 and/or extension arm 61 to the flange 51, 52 to capture part of the inlet and outlet duct housing 16, 18 by respective hook-like finger in the open area 62 thereof. In an embodiment, if desired, the hook-like fingers 31 may not have a detent 34a; in such case the hook-like fingers still may provide a resilient retention with the respective inlet and outlet duct housings 16, 18, e.g., as a surface of the extension arm engages the surface 33, 33′ of a respective inlet and outlet duct housing 16, 18.

Although the detents 34a are illustrated as protrusions 63, the detents alternatively or additionally may be recesses in the extension arm 61, for example, as will be described further below.

The lock 35, 35′ includes two lock portions 35a′ and 35a″. Each lock portion includes a ramp, 70′, 70″, a stop surface 71′, 71″, a support arm 72′, 72″ and a flex tab 73′, 73″. The lock portions 35a′, 35a″ cooperate with lock openings 35b′, 35b″ associated with the respective inlet and outlet duct housings 16, 18. The support arms 72′, 72″ support the respective ramp and stop surface from the respective flange 51, 52 and/or from the central housing portion 50 adjacent the respective flanges. The support arms 72′, 72″ are flexible and may be flexed in a direction toward the respective opposite flange by manually applying force to the respective support arms 72′, 72″ to release the respective stop surface 71′, 71″ from a lock opening 35b′, 35b″. The support arms also may flex to allow a respective ramp to slide along a wall bounding such a lock opening 35b′, 35b″ and to place a respective stop surface in the respective lock opening. The stop surfaces 71′, 71″ block sliding movement of the filter system 10 relative to a respective inlet or outlet duct housing 16, 18 when such stop surfaces are within a lock opening 35b′, 35b″ thereof.

A handle 74 is attached to or is molded as part of the housing 40 to facilitate manually manipulating the filter system 10 as it is installed in and removed from the inline fluid flow duct system 11.

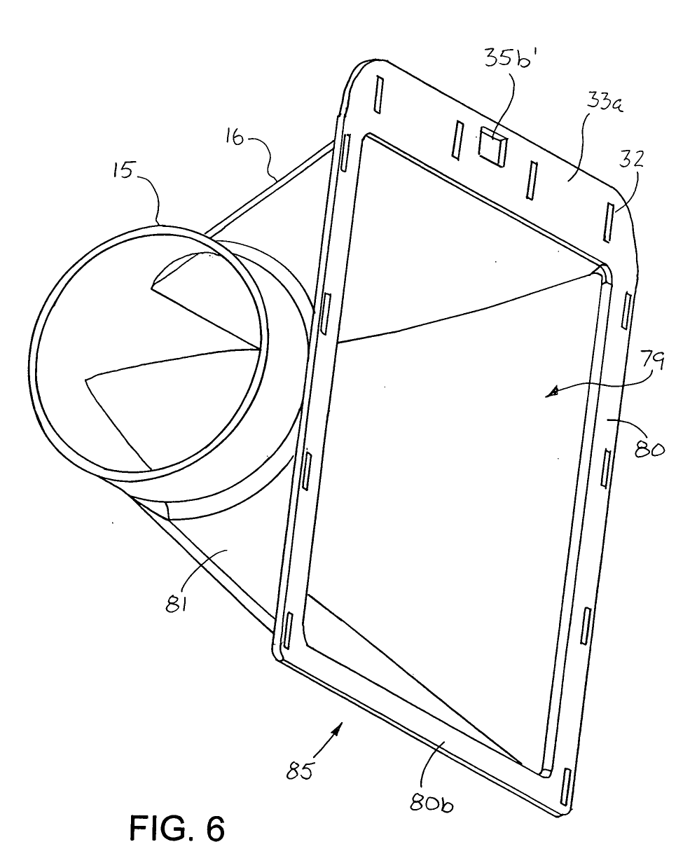

Referring to FIGS. 5 and 6, the inlet duct housing 16 is illustrated from two different directions, respectively, looking at the outside and at the inside of the inlet duct housing. The air inlet duct portion 13, flow inlet pipe 15 and air flow 17 are shown. An exemplary reinforcement member 78 that also may be used for grasping the inlet duct housing 16 may be provided at the outside thereof. As is seen in FIG. 6, the plenum area 79 is relatively wide open to allow for expansion of air and delivery to the filter system 10. Although not shown, various air flow controls, temperature sensors, butterfly valves, etc., may be provided the inlet duct housing; examples are illustrated in the drawing of the outlet duct housing 18, which is described further below.

A flange 80 is about the perimeter of the main housing portion 81 of the inlet duct housing 16. The inlet duct housing may be of plastic, metal or some other material of suitable strength, rigidity, longevity and ability to withstand temperatures to which it may be subjected, etc. Such material may be conventional and the inlet duct housing may be formed using conventional manufacturing techniques, e.g., plastic injection molding, metal forming, etc.

In the flange 80 is the lock opening 35b′ of the lock 35′. The lock opening and the walls or edges surrounding the lock opening, e.g., portions of the flange 80, cooperate with the lock 34a′, e.g., the stop surface 71′ thereof, of the filter system 10 to resist relative movement of the filter system 10 and the inlet duct housing 16 when the two are assembled in operative relation, e.g., as is shown schematically in FIG. 2 The support arm 72′ may be resiliently bent back to pull the stop surface 71′ clear from the lock opening 35b′ to allow the filter system 10 to be slid out such that the hook-like fingers exit the slots 32 to separate the filter system and inlet housing duct 16.

A number of slots 32 are in the flange 80. The slots 32 are of a size, orientation and configuration to receive respective hook-like fingers 31. Such hook-like fingers 31 may pass through the slots 32 such that the extension arms 61 thereof may slide along the surface 33 of the flange. The size, shape and orientation of the hook-like fingers 31 are such that upon such sliding, the hook-like fingers 31 apply a force to the surface 33 to pull the flange 80 toward the flange 51. Such pulling action tends to compress at least part of the gasket 42 between the flanges 51, 80 to provide a substantially air-tight seal between the inlet duct housing 16 and the housing 40 of the filter system 10.

The aforesaid pulling action may be effected by appropriate angles of one or more surfaces of the extension arms 61 so that the open area 62 between the extension arm and a surface of the flange 51 tapers or narrows in a direction toward the strut 60.

The aforesaid pulling action also may be effected by resilient biasing of the extension arm 61 away from the surface 33 as a protruding detent 63 is urged onto the surface 33 and slides along the surface 33. In this case the strut 60, extension arm 61 and/or the connection of the strut to the flange 51 provide suitable resilient characteristics to achieve the resilient force applied to the surface 33 to draw the housing 40 of the filter system 10 and the inlet duct housing 16 together.

A number of detents 34b are on the flange 80 in proximity to the slots 32. A detent rib 84 extends along the surface 80a of the flange 80 near an edge 80b opposite the edge at which the lock opening 35b′ is located. The detents 34b, 84 protrude out the major planar extent of the flange 80. The detents 34b, 84 are in position for cooperation with the protruding detents 63 of the hook-like fingers 31. For example, a protruding detent 63 that extends toward the surface 33 of the flange 80 may slide along the surface 33 and be urged over or across one of the detents 34b, 84. Such urging tends resiliently to deform the hook-like finger slightly to allow the protruding detent 63 to slide over the respective detent 34b, 84. After being slid over a detent 34b, 84, the protruding detent tends not to slide back over the detent 34b, 84 unless sufficient force is applied to overcome the resilient strength of the hook-like finger. Therefore, the connection between the housing 40 of the filter system 10 and the inlet duct housing 16 is maintained relatively securely and tends not to release without intentional urging of the respective hook-like fingers 31 back across respective detents 34b, 84 and also releasing of the appropriate lock 35, e.g., withdrawing the stop surface 71′ from the lock opening 35b′. Thus, it will be appreciated that the protruding detents 63 of the hook-like fingers 31 and the detents 34b, 84 of the inlet duct housing 16 provide for an interference fit or interference relation between respective pairs of detents to tend to preclude unintentional separating of the filter system 10 from the inline fluid flow duct system 11.

The arrangement of slots 32 facilitates aligning the filter system 10 and the inlet duct housing 16 for connecting them together. The portion 80a of the flange 80 at the bottom or back 85 of the inlet duct housing 16 (relative to the illustration of FIG. 5, for example) may be difficult to see or may be relatively inaccessible when installed in a vehicle, for example, and, thus, may make it relatively difficult to align hook-like fingers 31 with slots 32 that may be formed in the flange portion 80a. However, use of the rib protrusion detent 84 at the bottom or back of the inlet duct housing 16 at the flange portion 80a still allows the hook-like fingers to grasp the edge 80b of the flange portion 80a and to slide over the rib protrusion detent 84 to tend to resist being withdrawn, as was described above.

To connect the filter system 10 to the inlet duct housing 16, some of the hook-like fingers 31 are aligned with the respective slots 32 and with the bottom edge 80b of the flange portion 80a, and the flanges 51, 80 are placed generally in face to face relation adjacent each other. The extension arms 61 of some respective hook-like fingers 31 are urged through the slots 32 and are slid along the surface 33 of the flange 80. The hook-like fingers 31 adjacent the flange portion 80a slide across surface 33 and over the rib detent 84. Meanwhile, the ramp 70′ slides against the confronting surface 33a of the flange 80 until the stop surface 71′ resiliently snaps into the lock opening 35b′. Thereafter, to remove the filter system 10 from such connection with the inlet duct housing 16, the support arm 72′, which may be considered a flexible arm or flex tab, is resiliently bent to withdraw the stop surface 71′ from the lock opening 35b′, and the filter system 10 is slid relative to the inlet duct housing 16 to allow the protruding detents 63 to slide over the detents 34b, 84 and across the surface 33 of the flange 80 until the hook-like fingers release the inlet duct housing.

From the foregoing, it will be appreciated that the filter system 10 may be connected to and removed from the inlet duct housing 16 without the need for tools. Due to the resilient forces applied by the hook-like fingers 31 to draw the filter system 10 and inlet duct housing 16 toward each other, the gasket 42 may be sufficiently compressed to effect the desired fluid tight sealing function to avoid leakage of air between from the inline fluid flow duct system 11 at such connection.

Although not illustrated, an alternate arrangement of detents may be used. For example, one or more of the detents 63, 34b or 84 may be a recess rather than a protrusion. In this case the confronting detent may be a protrusion that fits into the recess detent. Operation of the connection between the filter system 10 and the inlet duct housing 16 would be the same or similar to that described above using pairs of protruding detents.

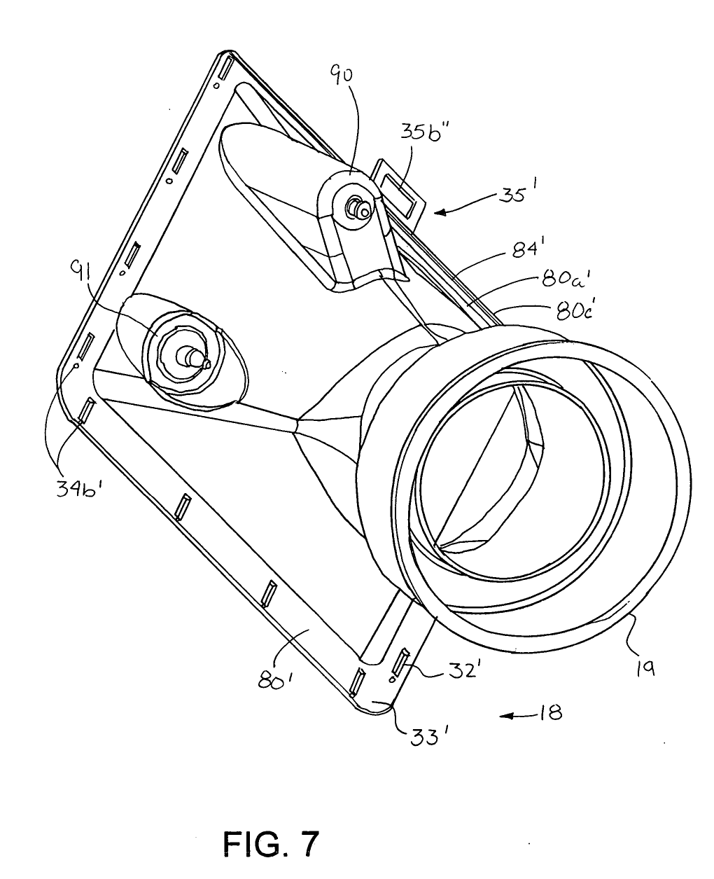

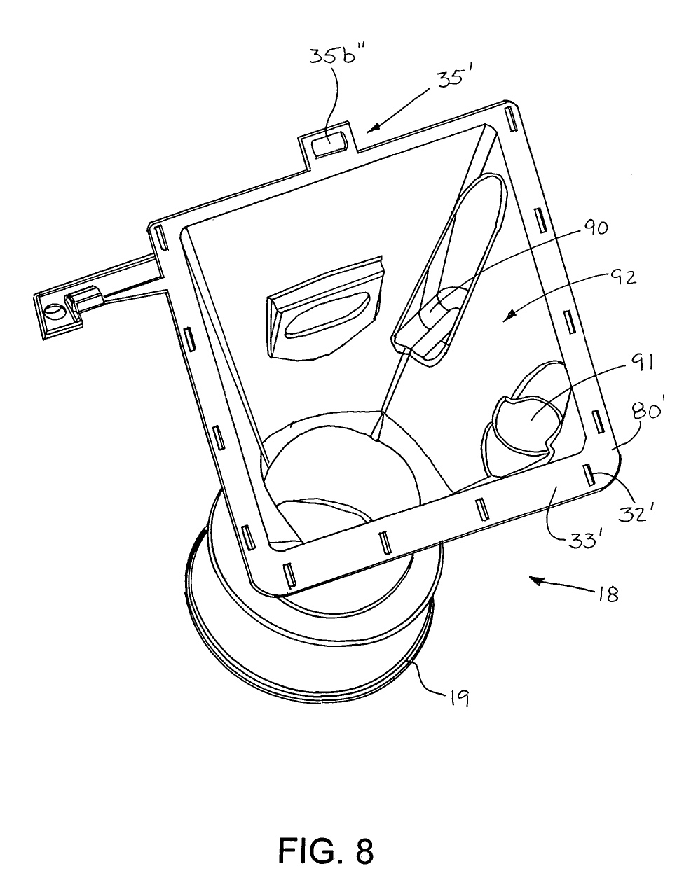

Referring to FIGS. 7 and 8, the outlet duct housing 18 is illustrated. The outlet duct housing is shown as part of the air outlet duct portion 14 with the outlet pipe 19. Several valves or flow controllers 90, 91 are shown in the outlet duct housing 18, e.g., butterfly valves, relief valves, etc. The valves 90, 91 and others, if used, may be controlled based manually, electronically, hydraulically, or pneumatically or by some other mechanism. The valves may be responsive to air pressure, flow rate, temperature, air requirements of the engine 12, etc., as is common in various air flow systems associated with engines and/or with other equipment. Such valves, controls, etc., also or alternatively may be included as part of the inlet duct housing 16, as was mentioned above.

In FIG. 7 the outside of the output duct housing 18 is illustrated. In FIG. 8 the view is looking into the interior 92 of the output duct housing showing the plenum thereof where air from the filter system 10 is collected and guided to the outlet pipe 19 for use, e.g., by the engine 12.

As is seen in FIGS. 7 and 8, the outlet duct housing 18 has a flange 80′, slots 32′, surface 33′, detents 34b′ rib 84′, surface 80a′, and edge 80c′, all of which are similar in form and function to those of the inlet duct housing 16 described above with respect to unprimed reference numerals. A difference between the inlet and outlet duct housings 16, 18 is that the detents are located differently. Whereas the hook-like fingers 31 that connect with the inlet duct housing 16 face toward the top edge of the flange 80, e.g., the edge at which the locking opening 35b′ is located, and the rib detent 84 is at the opposite (bottom) flange portion, in contrast the hook-like fingers 31′ that connect with the outlet duct housing 18 face in the opposite direction. Therefore, the detents 34b′ are at the opposite ends of the slots 32′ and the rib protrusion detent 84′ is at the top flange portion at which the locking opening 35b″ is located.

The filter system 10 may be attached to and removed from the outlet duct housing 18 generally in the manner described above with respect to attachment and removal with respect to the inlet duct housing 16. However, it will be appreciated that the stop surface 71″ of the lock 35a″ faces the opposite direction from the stop surface 71″ so that the two stop surfaces work in opposite directions to tend to preclude removing the filter system 10 from both the inlet and outlet duct housings 16, 18, respectively.

To attach the filter system 10 to the inlet duct housing 16, the hook-like fingers 31 are inserted into slots 32 and relative to the rib protrusion detent 84 and pulled toward the lock opening 35b′, e.g., toward the top part 80d of the flange 80. The gasket 42 provides a seal between the inlet duct housing 16 and the filter system 10. Removal is by sliding the filter system 10 in the opposite direction relative to the inlet duct housing 16.

To attach the filter system 10 to the outlet duct housing 18, the hook-like fingers 31′ are inserted into slots 32′ and relative to the rib protrusion detent 84′ and pushed away from the lock opening 35b″, e.g., toward the bottom 80d′ of the flange 80c. The gasket 42 provides a seal between the outlet duct housing 18 and the filter system 10. Removal is by sliding the filter system 10 in the opposite direction relative to the outlet duct housing 18.

Although the general shape of the filter system 10 and the inlet and outlet duct housings 16, 18 is rectangular, they may be of other shapes or configuration, e.g., circular, oval, other polygonal, etc. Also, although in several places directions are mentioned, these are presented to facilitate the description; and it will be appreciated that the parts and operation described may be related to other directions.

### INDUSTRIAL APPLICATION

As will be appreciated the invention may be used for filtering fluids using a filter system that is a section of an inline fluid flow duct system.

We claim:

1. A flat panel filter, comprising
a housing configured as a section of an inline fluid flow duct,
a filter in the housing, and
a connector configured to connect the housing with at least part of such an inline fluid flow duct,
the connector including at least one hook-like finger configured to engage an inline fluid flow duct to resist removal of the housing from such an inline fluid flow duct.

2. The flat panel filter of claim 1, the housing comprising an injected molded housing.

3. The flat panel filter of claim 2, the filter comprising part of the housing.

4. The flat panel filter of claim 3, the filter comprising paper material directly molded to the housing during injection molding of the housing.

5. The flat panel filter of claim 4, the filter comprising paper in V-fold configuration such that the directional extent of the legs of the V generally are in the direction of flow through the filter and respective apices of the Vs are upstream and downstream of the direction of flow through the filter.

6. The flat panel filter of claim 1, the housing being insertable as a section of an inline fluid flow duct system.

7. The flat panel filter of claim 6, wherein the housing has a fluid inlet side and a fluid outlet side, and wherein the connector comprises at least one hook-like finger at the fluid inlet side and at least one hook-like finger at the outlet side, the hook-like fingers configured for positioning in slots of and for sliding engagement with respect to respective fluid ducts of an inline fluid duct system, and having an interference detent to engage a portion of a respective fluid duct to impede such sliding.

8. The flat panel filter of claim 7, wherein said interference detents are protruding tabs and the open portion of the hook-like finger at the fluid inlet side faces the opposite direction from the open portion of the hook-like finger at the fluid outlet side.

9. The flat panel filter of claim 1, wherein the housing is generally rectangular and the connector comprises a number of hook-like fingers proximate from one to three of the of the sides of the rectangularly configured i housing and there are no hook-like fingers proximate the fourth side of the rectangularly configured housing.

10. The flat panel filter of claim 9, wherein the housing has a fluid inlet side and a fluid outlet side, the connector comprises hook-like fingers at the fluid inlet side and at the outlet side, and the open portion of the hook-like fingers at the fluid inlet side face the opposite direction from the open portion of the hook-like fingers at the fluid outlet side.

11. The flat panel filter of claim 10, further comprising a lock to hold the housing in position relative to a fluid duct of an inline fluid flow duct system with the hook-like fingers holding the housing to such a fluid duct.

12. The flat panel filter of claim 1, wherein the housing is generally rectangular and the connector comprises a number of hook-like fingers proximate a number of the sides of the rectangularly configured housing, and further comprising a lock to hold the housing in position relative to a fluid duct of an inline fluid flow duct system with the hook-like fingers holding the housing to such a fluid duct.

13. The flat panel filter of claim 1, further comprising a gasket about a perimeter portion of the housing, and the hook-like finger comprising a plurality of hook-like fingers that have a resilient portion cooperable with at least part of a fluid duct of an inline fluid flow duct system resiliently to pull the gasket toward such a fluid duct to provide a fluid seal between the flat panel filter and such fluid duct.

14. The flat panel filter of claim 13, said housing comprising a molded plastic or plastic-like material, said gasket being molded directly to said housing.

15. The flat panel filter of claim 1, further comprising a gasket about a perimeter portion of the housing, wherein the housing is generally rectangular, the connector comprises a number of hook-like fingers proximate a number of the of the sides of the rectangularly configured housing, and the hook-like fingers comprising a plurality of hook-like fingers that have a resilient portion cooperable with at least part of a fluid duct of an inline fluid flow duct system resiliently to pull the gasket toward such a fluid duct to provide a fluid seal between the flat panel filter and such fluid duct.

16. The flat panel filter of claim 15, said hook-like fingers being at least approximately uniformly spaced along respective sides of the housing to apply generally uniform force to the gasket for sealing effect.

17. The flat panel filter of claim 1, the housing comprising a plastic housing having an inlet end and an outlet end, a flow path from the inlet end to the outlet end via the filter, the hook-like fingers comprising a number of hook-like fingers integral with the plastic housing and extending from the inlet end in an upstream direction, a number of hook-like fingers integral with the plastic housing and extending from the outlet end in a downstream direction, the open portion of the hook-like fingers at the inlet end facing the opposite direction from the open portion of the hook-like fingers at the outlet end, whereby the hook-like fingers at one end provide for sliding engagement in a first direction with a fluid duct of an inline fluid duct system and the hook-like fingers at the other end provide for sliding engagement in the opposite direction with a fluid duct of such inline fluid duct system.

18. The flat panel filter of claim 17, further comprising selectively operable locking members respectively at opposite ends of the housing cooperable with corresponding respective locking elements of such fluid ducts of such inline fluid duct system to hold the housing in position relative to such fluid ducts with the hook-like fingers holding the housing to such fluid ducts.

19. The flat panel filter of claim 1, and further comprising in combination therewith an inline fluid duct system having an inlet fluid duct portion and an outlet fluid duct portion, each fluid duct portion having a number of slots for receiving a respective hook-like finger of the connector of the flat panel filter, said hook-like fingers having a first leg extending generally away from a major portion of the housing and a second leg extending generally at a right angle with respect to the first generally linear leg, and said hook-like fingers including tabs at least approximately at the distal end of the second generally linear leg relative to the first leg and protruding in a direction toward the major portion of the housing for sliding engagement with a surface of a respective fluid duct portion, the inlet and outlet fluid duct portions of the inline fluid duct system having respective surfaces along which the respective tabs may slide during connecting and disconnecting the flat panel filter with respective fluid duct portions, the dimensions of the connector and of the inlet and outlet fluid duct portions being such that with the flat panel filter connected in the inline fluid duct system the tabs of hook-like fingers are resiliently biased against such respective surfaces to draw the housing and the respective duct portions together.

20. A flat panel filter to filter air flowing in an inline fluid duct system as an air supply system for an engine, comprising
a housing configured as a section of an inline fluid flow duct of an inline fluid duct system, the housing having a flow path including a fluid inlet to receive air flow from an inlet fluid duct portion of such inline fluid duct system and a fluid outlet to provide air flow to an outlet fluid duct portion of such inline fluid duct system,
a filter in the housing, and
a connector configured to connect the housing as an inline fluid flow section of such inline fluid duct system between such inlet fluid duct portion and outlet fluid duct portion of such an inline fluid duct system,
the connector including a number of hook-like fingers of the housing, respectively, at least proximate a respective fluid inlet and fluid outlet of the housing to provide a sliding relation and resiliently biased connection with respective inlet and outlet fluid duct portions of such inline fluid duct system.

21. The flat panel filter of claim 20, and further comprising in combination therewith an inline fluid duct system having an inlet fluid duct portion and an outlet fluid duct portion, each fluid duct portion having a number of slots for receiving a respective hook-like finger of the connector of the flat panel filter, said hook-like fingers having a first leg extending generally away from a major portion of the housing and a second leg extending generally at a right angle with respect to the first generally linear leg, and a tab at least approximately at the distal end of the second generally linear leg relative to the first leg and protruding in a direction toward the major portion of the housing for sliding engagement with a surface of a respective fluid duct portion, the inlet and outlet fluid duct portions of the inline fluid duct system having respective surfaces along which the respective tabs may slide during connecting and disconnecting the flat panel filter with respective fluid duct portions, the dimensions of the connector and of the inlet and outlet fluid duct portions being such that with the flat panel filter connected in the inline fluid duct system the tabs of hook-like fingers are resiliently biased against such respective surfaces to draw the housing and the respective duct portions together.

22. The flat panel filter and inline fluid duct system of claim 21, wherein the surfaces of the fluid duct portions along which the tabs slide include interference surfaces for interfering with sliding movement of respective tabs and requiring additional force to overcome the resilience of the hook-like fingers to move the respective tabs over such interfering surfaces.

23. The flat panel filter and inline fluid duct system of claim 21, further comprising selectively operable locking members respectively at opposite ends of the housing cooperable with corresponding respective locking elements of such fluid duct portions of such inline fluid duct system to hold the housing in position relative to such fluid duct portions with the hook-like fingers holding the housing to such fluid ducts.

24. The flat panel filter and inline fluid duct system of claim 21, further comprising respective gaskets between the filter panel and the fluid duct portions, and wherein the hook-like fingers resiliently draw the flat filter panel and the respective fluid duct portions together to engage the respective gaskets in substantially fluid tight relation.
